(19) United States
(12) Patent Application Publication
(10) Pub. No.: US 2018/0033365 A1
(43) Pub. Date: Feb. 1, 2018

(54) DISPLAY DEVICE AND PIXEL CIRCUIT THEREOF

(71) Applicant: PEKING UNIVERSITY SHENZHEN GRADUATE SCHOOL, Shenzhen (CN)

(72) Inventors: Shengdong ZHANG, Shenzhen (CN); Cuicui WANG, Shenzhen (CN); Chuanli LENG, Shenzhen (CN)

(73) Assignee: PEKING UNIVERSITY SHENZHEN GRADUATE SCHOOL, Shenzhen (CN)

(21) Appl. No.: 15/550,982

(22) PCT Filed: Mar. 17, 2016
(86) PCT No.: PCT/CN2016/076554

§ 371 Date: Aug. 14, 2017

(30) Foreign Application Priority Data
Apr. 21, 2015 (CN) 201510191747.4

(51) Int. Cl. G09G 3/3233; G09G 3/3291; G09G 3/3266; G09G 3/20

(52) U.S. Cl. CPC G09G 3/3233; G09G 3/2018; G09G 3/3291; G09G 3/3266; G09G 2300/0426; G09G 2320/064; G09G 2310/08; G09G 2320/0233; G09G 2310/0289

(57) ABSTRACT

A display device and a pixel circuit thereof. The pixel circuit generates threshold voltage information of a driving transistor (21) in a source following manner, a threshold voltage of the driving transistor (21) and a reference voltage related to gray scale information are generated at two ends of a first capacitor (26) by means of voltage division of the first capacitor (26) and a second capacitor (27), and the reference voltage keeps unchanged during a light-emitting process, so that a driving current flowing through a light-emitting device (25) is irrelevant to threshold voltages of the driving transistor (21) and the light-emitting device (25), thereby compensating the threshold voltage deviation of the driving transistor (21) and the light-emitting device (25), and solving the problem of nonuniform display. When the display device emits light line by line, the display device reduces the line programming time of the circuit by overlapping scanning signals and control signals, so that the demands for high-resolution and high-frame-frequency display panels are met while high precision is obtained. When the display device emits light in a concentrated manner, the pixel circuit reduces the complexity of the circuit and increases the light-emitting time by means of grouped programming and grouped light emission.

### TECHNICAL FIELD

This present disclosure relates to display field, more particularly, to a display device and a pixel circuit thereof.

### BACKGROUND

In recent years, organic light-emitting diodes (OLED) display has been widely studied and it is rapidly applied in the new generation display applications, this is because OLED display owns the merits of high brightness, high luminous efficiency, wide viewing angle, low power consumption and low fabrication cost. According to pixel driving method, OLED display can be divided into two types, namely PMOLED (Passive Matrix OLED) and AMOLED (Active Matrix OLED). Although the cost of PMOLED is low, it has the large cross talk and large current is required. Thus, PMOLED has the disadvantages of short lifetime and high power consumption, which cannot meet the requirements of large area display with high-resolution applications. In contrast, in the case of AMOLED, the issues of duty cycle and crosstalk are avoided, less driving current is required, and lower power consumption with longer lifetime can be obtained. Therefore, it is easier for AMOLED to meet the requirements of large area display with high resolution and high gray levels.

The conventional AMOLED pixel circuit consists of two thin film transistors (short for TFT in the following descriptions) and a storage capacitor, as shown in FIG. 1. The pixel circuit includes a driving transistor 11, and switching transistors 12, and storage capacitor 13 and a light emitting device OLED 14. And switch transistor 12 is controlled by scan control line 15, thus data signal can be sampled from data line 16 and provided to the gate of the drive transistor 11, which generates current for OLED 14 corresponding to the required gray level. And the gray level information can be stored by storage capacitor 13, and data is maintained by capacitor storage 13 until the next frame. The current flowing through the OLED 14 in the pixel circuit can be expressed as:

$${I}_{OLED} = \frac{1}{2} {μ}_{n} {C}_{ox} \frac{W}{L} {( {V}_{G} - {V}_{OLED} - {V}_{TH} )}^{2} \qquad ( 1 )$$

Where μₙ and Cₒₓ are the effective field-effect mobility and gate capacitance per unit area of the transistor 11. And W and L are the effective channel width and channel length of the TFT devices, respectively. V_{G} is the gate voltage of the drive transistor 11, V_{OLED} is the biasing voltage of OLED for emitting phase and V_{TH} is the threshold voltage of the drive transistor.

Although the circuit structure is simple, there is luminance non-uniformity issue. When the threshold voltage (V_{TH}) of driving transistor 11 shift, or V_{OLED} of OLED 14 increases due to the OLED degradation with time, or V_{TH} of drive transistor varies due to adopting of poly-silicon material, the current through the OLED 14 will change with time or space position.

### SUMMARY

The present disclosure provides a display device and a pixel circuit, and the threshold voltage shift of the driving transistor and OLED can be compensated. And the luminance non-uniformity issue caused by threshold voltage variations of display panel can also be solved.

According to the first aspect of the present disclosure, a pixel circuit is provided,

wherein a frame time of the pixel circuit comprises an initialization stage, a threshold extraction stage, a data writing stage and an emitting stage, and the pixel circuit comprises:

a first transistor and a light emitting device, which are serially connected between a high voltage level and a low voltage level, and the first transistor is configured to provide a driving current for the light emitting device for the light emitting phase, and the light emitting device is configured to emit light according to the driving current, and the high voltage level is provided by a first voltage source, and the low voltage level is provided by a second voltage source;

a second transistor, which is connected between a data line and a control electrode of the first transistor, and a control electrode of the second transistor is connected with a first scan control terminal for receiving a first scan control signal to select the pixel circuit, and the second transistor is turned on by the first scan control signal for applying data voltage of data line to a control electrode of the first transistor, and thus the first transistor can be controlled to provide the driving current for the light emitting device;

a storage unit, being connected between the control electrode of the first transistor and the second voltage source, or being connected between the control electrode of the first transistor and a fifth voltage source, and the second voltage source and the fifth voltage source is used to provide the low voltage level for storing the data voltage of the data line; wherein the storage unit comprises a first capacitance, a second capacitance and a third transistor, and the first capacitance and the second capacitance are connected between the control electrode of the first transistor and the low voltage level, and providing a reference voltage for the control electrode of the first transistor for the initialization phase and the threshold extraction phase, and a first electrode of the third transistor is connected with the junction node of the first capacitance and the second capacitance, a second electrode of the third transistor is connected with the junction node of the first transistor and the light emitting device, and a initial voltage is coupled with the second electrode of the third transistor for the initialization phase, and the control electrode of the third transistor is connected with a second scan control terminal for receiving a second scan control signal, and the third transistor is turned off by the second scan control signal for the data writing phase.

For the first embodiment, the second transistor is turned on by the first scan control signal for the initialization phase, and the threshold extraction phase, and the data writing phase, and the reference voltage is provided by the data line, and the reference voltage is coupled to the control electrode of the first transistor under the control of the first scan control signal by the second transistor; and the initial voltage is provided by the first voltage source, and the initial voltage is coupled to the second electrode of the third transistor through the first transistor.

For the second embodiment, the reference voltage is provided by the data line, and the reference voltage is coupled to the control electrode of the first transistor for the initialization and threshold extraction phases by the second transistor; the pixel circuit further comprises a fourth transistor, wherein a first electrode of the fourth transistor is connected with the junction node of the first transistor and the light emitting device, and a second electrode of the fourth transistor is connected with a third voltage source, and a control electrode of the fourth transistor is connected with a third scan control terminal; and the third scan control terminal is used for receiving a third scan control signal, and the fourth transistor is turned on by the third scan control signal, thus an initial voltage of the third voltage source is coupled to the junction node of the first transistor and the light emitting device.

For the third embodiment, the initial voltage of the first voltage source is coupled to the junction node of first transistor and the light emitting device through the first transistor for the initialization phase, and the pixel circuit further comprises a fifth transistor, wherein a first electrode of the fifth transistor is connected with a fourth voltage source, and a second electrode of the fifth transistor is connected with the control electrode of the first transistor, and a control electrode of the fifth transistor is connected with a fourth scan control terminal; and the fourth scan control terminal is used to receive a fourth scan control signal; and the fifth transistor is used to couple the reference voltage of the fourth voltage source to the control electrode of the first transistor for the initialization phase and the threshold extraction phase.

For the fourth embodiment, the mentioned pixel circuit further comprises:

a fourth transistor, wherein a first electrode of the fourth transistor is connected to junction node of the first transistor and the light emitting device, and a second electrode of the fourth transistor is connected to a third voltage source, and a control electrode of the fourth transistor is connected to a third scan control terminal; and the third scan control terminal is used to receive a third scan control signal; and the fourth transistor is used to couple an initial voltage of the third voltage source to the junction node of the first transistor and the light emitting device; and

a fifth transistor, wherein a first electrode of the fifth transistor is connected to a fourth voltage source, and a second electrode of the fifth transistor is connected to the control electrode of the first transistor, and a control electrode of the fifth transistor is connected to a fourth scan control terminal; and the fourth scan control terminal is used to receive a fourth scan control signal; and the fifth transistor is used to couple a reference voltage of the fourth voltage source to the control electrode of the first transistor for the initialization phase and the threshold extraction phase.

For the fifth embodiment, the initial voltage and the reference voltage are provided by the data line, and the second transistor is used to couple the initial voltage of the data line to the control electrode of the first transistor for the initialization phase, and couple the reference voltage of the data line to the control electrode of the first transistor for the threshold extraction phase; and the pixel circuit further comprises: a fourth transistor, wherein a first electrode of the fourth transistor is connected with the junction node of the first transistor and the light emitting device, and a second electrode of the fourth transistor is connected with the control electrode of the first transistor, and a control electrode of the fourth transistor is connected with a third scan control terminal; the third scan control terminal is used to receive a third scan control signal, and the fourth transistor is turned on by the third scan control signal, thus the initial voltage of the control electrode of the first transistor can be coupled to the junction node of the first transistor and the light emitting device.

For the sixth embodiment, the initial voltage and the reference voltage are provided by the data line, and the second transistor is used to couple the reference voltage of the data line to the control electrode of the first transistor for the threshold extraction phase; and the pixel circuit further comprises: a fourth transistor, wherein a first electrode of the fourth transistor is connected with the junction node of the first transistor and the light emitting device, and a second electrode of the fourth transistor is connected with data line, and a control electrode of the fourth transistor is connected with the third scan control terminal which is used to receive the third scan control signal; and the fourth transistor is turned on by the third scan control signal, thus the initial voltage of the data line is coupled to the junction node of the first transistor and the light emitting device.

Or the initial voltage and the reference voltage are provided by the data line, and the second transistor is used to couple the reference voltage of the data line to the control electrode of the first transistor for the threshold extraction phase; and the pixel circuit further comprises: a fourth transistor, wherein a first electrode of the fourth transistor is connected to the junction node of the first capacitance and the second capacitance, and a second electrode of the fourth transistor is connected with the data line, and a control electrode of the fourth transistor is connected with the third scan control terminal, and the third scan control terminal is used to receive the third scan control signal; the fourth transistor is turned on by the third scan control signal, thus the initial voltage of the data line can be coupled to the junction node of the first capacitance and the second capacitance.

Further, the mentioned initial voltage is less than threshold voltage of the light emitting device, and the difference of mentioned reference voltage and the threshold voltage of the first transistor is less than the threshold voltage of the light emitting device. Moreover, the difference of maximum value of the data voltage of the first transistor and the threshold voltage of the first transistor is less than the threshold voltage of the light emitting device.

According to second aspects of the present disclosure, a display device is provided, comprising:

a display panel, with pixel matrix of M column *N row, and the pixel circuit can be realized by any of the above mentioned structure, where M and N are positive integers;

a gate drive circuit for providing the first and the second scan control signals, wherein the number of the first and second scan control signals lines are both N, and the n-th first and second scan control lines are connected with the n-th first and second scan control terminals, respectively, wherein n is an integer greater than or equal to 1 and less than or equal to N; thus, the first and the second scan control line are providing the first and the second scan control signal for the pixels of the corresponding lines, respectively; moreover, the mentioned first power supply line is used for providing the initial voltage for the pixel circuit of the corresponding lines for initializing phase;

a data driving circuit, configured to provide data signals for the M data lines, and to provide the first voltage source for an X first voltage source lines; wherein an m-th data line is connected with the pixel circuits of the m-th columns, and m is an integer larger than or equal to 1, and less than or equal to M; and the data line is configured to provide the reference voltage for the initialization phase and the threshold extraction phase, and also provide gray level related data voltage for data writing phase, for the pixel circuits of corresponding columns, wherein X is an integer greater than or equal to 1, and less than or equal to N, and the value of X depends on the number of pixel circuits that are initialized and threshold voltage extracted simultaneously; in the case there are pixels of x rows being initialized simultaneously, then X=N/x; and in the case X=N, the pixel circuit of the display panel is emitting row by row; and in the case X=1, then pixel circuits of the display panel is emitting simultaneously; and in the case X is greater than 1 and less than N, pixel circuits for the display panel is divided into X groups, and pixel circuits within the same group finishes the initialization phase simultaneously, and also finishes the threshold extraction phase simultaneously, and also finish the light emitting phase simultaneously; and the first voltage source provides the first voltage source for the pixel circuits;

wherein the second transistor is turned on by the first scan control signal, for the initiation phase, and the threshold voltage phase, and the data writing phase according to the first scan control signal; the reference voltage provided by the data line is coupled to the control electrode of the first transistor through the second transistor corresponding to the first scan control signal; and the initial voltage provided by the first voltage source is coupled to the second electrode of the third transistor, and also to the junction node of the first capacitance and the second capacitance through the first transistor;

a constant voltage source of the second voltage source and the fifth voltage source is provided by external circuits.

According to a second embodiment of the display device, wherein the pixel circuit further comprises:

a fourth transistor, wherein a first electrode of the fourth transistor is connected to the junction node of the first transistor and the light emitting device, and a second electrode of the fourth transistor is connected with a third voltage source, and a control electrode of the fourth transistor is connected with a third scan control terminal; and the third scan control terminal is configured to receive a third scan control signal; and the fourth transistor is configured to couple an initial voltage of the third voltage source to the junction node of the first transistor and the light emitting device;

a fifth transistor, wherein a first electrode of the fifth transistor is connected with a fourth voltage source, and a second electrode of the fifth transistor is connected with the control electrode of the first transistor, and a control electrode of the fifth transistor is connected with a fourth scan control terminal; and the fourth scan control terminal is configured to receive a fourth scan control signal; the fifth transistor is configured to couple a reference voltage of the fourth voltage source to the control electrode of the first transistor during the initialization phase and the threshold extraction phase;

a gate drive circuit, configured for providing respective scan control signals for first scan control lines with the number of N, and second scan control lines with the number of N, and third scan control lines with the number of N, and fourth scan control lines with the number of N; the n-th first scan control signal is connected with the first scan control terminal of the pixel circuit of the n-th row, and the n-th second scan control signal is connected with the second scan control terminal of the pixel circuit of the n-th row, and the n-th third scan control signal is connected with the third scan control terminal of the pixel circuit of the n-th row, and the n-th fourth scan control signal is connected with the fourth scan control terminal of the pixel circuit of the n-th row, wherein n is an integer larger than or equal to 1, and less than or equal to N, wherein the first scan control line is configured to provide the first scan control signal for the pixels of corresponding row, and the second scan control line is configured to provide the second scan control signal for the pixels of corresponding row, and the third scan control line is configured to provide the third scan control signal for the pixels of corresponding row, and the fourth scan control line is configured to provide the fourth scan control signal for the pixels of corresponding row, and the third voltage source is configured to provide initial voltage for pixels of every row, and the fourth voltage source is configured to provide reference voltage for pixels of every row; and

a data driving circuit, configured for providing voltage signal for M data lines, wherein m-th data line is connected with the pixel circuit of the m-th row, wherein m is greater than or equal to 1, and less than or equal to M; and the data line is used to provide reference voltage and gray level related data voltage for the initialization phase, the threshold extraction phase, and the data writing phase;

wherein the constant voltage source of the first voltage source, the second voltage source, the third voltage source, the fourth voltage source, and the fifth voltage source are all provided by the external circuits.

According to a third embodiment of the display device, comparing with the display device of the above mentioned embodiments, wherein the gate driver doesn't include the third scan control line and the fourth scan control line, and the fourth scan control terminal of the pixel circuits of the n-th row is connected with the first scan control line of the pixel circuit of the (n-a)-th row, and the third scan control terminal of the pixel circuits of the n-th row is connected with the first scan control terminal of the pixel circuits of the (n-a-b)-th row, wherein a is an integer larger than or equal to 1, and less than n; and b is an integer larger than or equal to 1, and less than (n-a).

According to a fourth embodiment of the display device, wherein the pixel circuit further comprises:

a fourth transistor, wherein a first electrode of the fourth transistor is connected to the junction node of the first transistor and the light emitting device, and a second electrode of the fourth transistor is connected to the data line, and a control electrode of the fourth transistor is connected to a third scan control terminal; and the third scan control terminal is configured to receive a third scan control signal; the initial voltage is provided by the data driving circuit rather than the first voltage source; and the fourth transistor is configured to couple the initial voltage of the data line to the junction node of the first transistor and the light emitting device as well as the junction node of the first capacitance and the second capacitance; or

the first electrode of the fourth transistor is connected to the junction node of the first capacitance and the second capacitance, and the second electrode of the fourth transistor is connected with the data line, and the control electrode of the fourth transistor is connected with the third scan control terminal, and the third scan control terminal is used to receive the third scan control signal; the initial voltage is provided by the data driving circuit rather than the first voltage source, wherein the fourth transistor is configured to couple the initial voltage of the data line to the junction node of the first transistor and the light emitting device as well as the junction node of the first capacitance and the second capacitance; or

the first electrode of the fourth transistor is connected to junction node of the first transistor and the light emitting device, and the second electrode of the fourth transistor is connected to the control electrode of the first transistor, and the control electrode of the fourth transistor is connected to the third scan control terminal; and the third scan control terminal is configured to receive the third scan control signal; the initial voltage is provided by the data driving circuit rather than the first voltage source, wherein the fourth transistor is configured to couple the initial voltage of the data line to the junction node of the first transistor and the light emitting device as well as the junction node of the first capacitance and the second capacitance;

a gate driving circuit, configured for providing respective scan control signals for first scan control lines with the number of N, and second scan control lines with the number of N, and third scan control lines with the number of N; the n-th first scan control signal is connected with the first scan control terminal of the pixel circuit of the n-th row, and the n-th second scan control signal is connected with the second scan control terminal of the pixel circuit of the n-th row, and the n-th third scan control signal is connected with the third scan control terminal of the pixel circuit of the n-th row, wherein n is an integer larger than or equal to 1, and less than or equal to N,

wherein the first scan control line is configured to provide the first scan control signal for the pixels of corresponding rows, and the second scan control line is used to provide the second scan control signal for the pixels of corresponding rows, and the third scan control line is used to provide the third scan control signal for the pixels of corresponding rows; and

a data driving circuit, configured for providing voltage signal for M data lines, wherein m-th data line is connected with the pixel circuit of the m-th row, wherein m is greater than or equal to 1, and less than or equal to M; and the data line is configured to provide reference voltage and gray level related data voltage for the initialization phase, the threshold extraction phase, and the data writing phase;

wherein the constant voltage source of the first voltage source, the second voltage source, the third voltage source, the fourth voltage source, and the fifth voltage source are all provided by the external circuits.

For the display device and pixel circuits in the present disclosure, threshold voltage of the driving transistor is generated through the source following method, and a reference driving voltage, containing the threshold voltage of the driving transistor and gray level information, can be generated according to the voltage ratio of the first and second capacitance. Thus for the light emitting phase, the reference driving voltage can be maintained, and the driving current of the light emitting device is independent of the threshold voltage of the driving transistor and the light emitting device. So the non-uniformity issue of the display panel caused by the threshold voltage variations can be compensated. In the case of row-by-row driving display, the scan control signals are overlapped to reduce the row programming time of the circuit. Thus, high-resolution display with high frame rate can be satisfied, and high compensating accuracy can be obtained. In addition, in the case of simultaneous emitting, group divided programming and emitting can be used, thus the circuit complexity can be decreased and the emitting time can be increased.

### BRIEF DESCRIPTION OF THE DRAWINGS

FIG. 1 shows the pixel circuit structure of the prior art;

FIG. 2 is the pixel circuit structure of the first embodiment;

FIG. 3 is the driving signal waveform of the first embodiment;

FIG. 4 is the pixel circuit structure of the second embodiment;

FIG. 5 is the driving signal waveform of the second embodiment;

FIG. 6 shows the pixel circuit structure of the third embodiment;

FIG. 7 is the driving signal waveforms of the third embodiment;

FIG. 8 shows the display apparatus structure being composed of pixel circuits as shown in the third embodiment;

FIG. 9 shows the pixel circuit structure of the fourth embodiment;

FIG. 10 is the driving signal waveform for the pixel circuit of the fourth embodiment;

FIG. 11 shows the pixel circuit structure of the fifth embodiment;

FIG. 12 is the driving signal waveform for the pixel circuit of the fifth embodiment;

FIG. 13 shows the pixel circuit structure of the sixth embodiment;

FIG. 14 shows the drive signal waveform for the pixel circuit of the sixth embodiment;

FIG. 15 shows the pixel circuit structure of the seventh embodiment;

FIG. 16 shows the driving signal waveform for the pixel circuit of seventh embodiment;

FIG. 17 is the driving diagram for the eighth embodiment when all the pixels are treated as one group;

FIG. 18 is the driving diagram for the eighth embodiment when all the pixels are divided to two groups;

FIG. 19 is the driving diagram for the eighth embodiment when all the pixels are divided to four groups;

FIG. 20 shows the pixel circuit structure of the eighth embodiment;

FIG. 21 is the driving signal waveform for the pixel circuit of the eighth embodiment;

FIG. 22 is the display apparatus structure of the eighth embodiment;

FIG. 23 shows the pixel circuit structure of the ninth embodiment;

FIG. 24 shows the driving signal waveform for the pixel circuit of the ninth embodiment;

FIG. 25 shows the pixel circuit structure of the tenth embodiment;

FIG. 26 shows the pixel circuit structure of the other embodiment;

FIG. 27 is the display apparatus structure of the tenth embodiment.

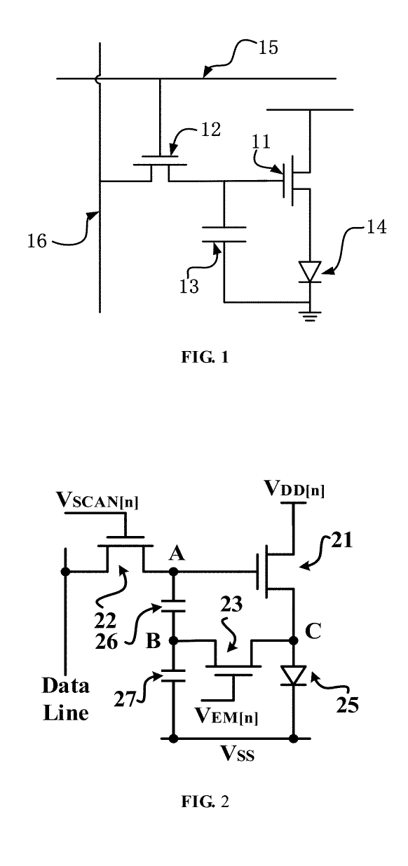

### DETAILED DESCRIPTION

First, some of the terms used in the present disclosure are described as follows. The transistors used in this disclosure can be of any structure type, such as field effect transistors (FET) or bipolar transistors (BJT). In the case of FET, the control electrode refers to the gate electrode, the first electrode is the drain electrode, and the second electrode is the source electrode. While in the case of BJT, the control electrode refers to the base electrode, the first electrode is the collector electrode, and the second electrode is the emitter electrode. When the transistor is used as a switch, the drain and the source can be interchanged. As TFT devices are widely used in display applications, in this disclosure, all the embodiments are mainly focusing on implementations using TFTs. And the light emitting device is OLED in this disclosure. Except for illustrated specially, all the transistors used in this disclosure are N-type.

The embodiments of the present disclosure are further described below in detail with the accompanying drawings.

### First Embodiment

The pixel circuit is provided in this embodiment as shown in FIG. 2, which includes the first transistor 21, the second transistor 22, the third transistor 23, the first capacitance 26, the second capacitance 27, and the light emitting device 25.

The first transistor 21 and the light emitting device 25 are connected in series between the first voltage source V_{DD[n]} and the second voltage source V_{SS}. Control electrode of the first transistor 21 is connected to the second electrode of the second transistor 22, and the first electrode of transistor 21 first connected to the first voltage source, and the second electrode of first transistor 21 is connected to anode electrode of the light emitting device 25.

The control electrode of the second transistor 22 is connected to the first scan control signal V_{SCAN[n]}, for receiving a first scan control signal of the current gate line. In addition, the first electrode of the second transistor 22 is connected to the Data line, for receiving the data signal of Data line (data voltage). And the second electrode of the second transistor 22 is used to transfer data voltage containing the reference voltage and gray level information, corresponding to the first scan control signal of the current line.

The control electrode of the third transistor 23 is connected to the second scan control line V_{EM[n]} for receiving the second scan control signal of the current gate line. In addition, the first electrode of the third transistor 23 is connected to the anode of the first light emitting device 25, and the third electrode of the second transistor 23 is connected to the second electrode of the first capacitor 26. The third transistor 23 is turned on by the second scan control signal of the current gate line, for the initialization, threshold extraction and light emitting phase.

The first electrode of the first capacitor 26 is connected to the control electrode of the first transistor 21, and the second electrode of the first capacitor 26 is connected to the first electrode of the second capacitor 27. In addition, the second electrode of the capacitor 27 is connected to the second voltage source V_{SS}. For the threshold extraction phase, the voltage difference of the first capacitance 26 contains the threshold voltage information of the driving transistor (the first transistor 21). And for the data writing phase, a reference driving voltage, which contains the gray level and threshold voltage of driving transistor, can be stored at the two electrodes of the first capacitance 26 through voltage division of the first capacitance 26 and the second capacitance 27. And for the light emitting phase, the voltage information of the OLED (light emitting device 25) can be coupled to the gate electrode of the first transistor 21 through bootstrapping method, thus the mentioned reference driving voltage of the first capacitance 26 will be maintained constantly. It is worth pointing that, the second electrode of the second capacitance 27 is connected with the second voltage source V_{SS} in this embodiment. And in other implementations, the second electrode of the second capacitance 27 can be connected with an independent fifth voltage source.

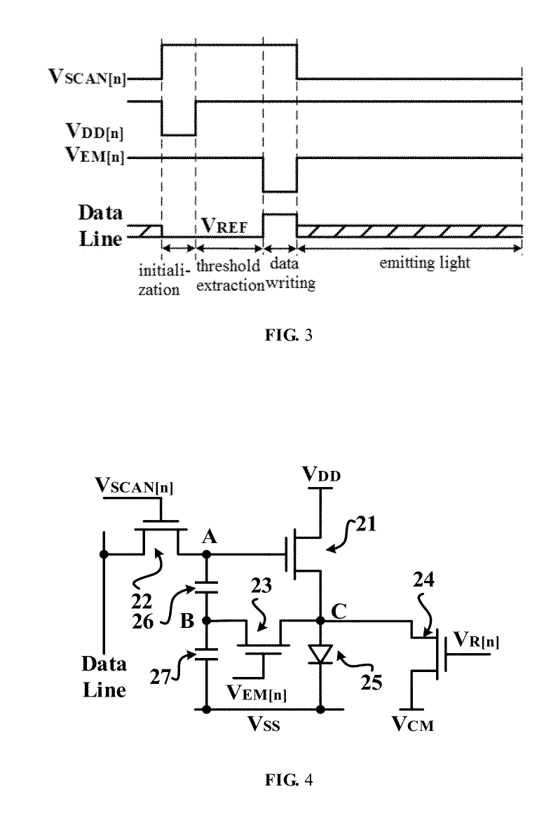

The driving signal waveform for the pixel circuit of the embodiment is shown in FIG. 3. And a frame time T (one frame period) for the operating of the pixel circuit can be divided into four phases: initializing phase, threshold extraction phase, data writing phase and light emitting phase. For the simplicity of description, the junction node of the control electrode of the first transistor 21 and the second electrode of the second transistor 22 is denoted as the first node A. In addition, the junction node of the second electrode of the first capacitance 26 and the first electrode of the second capacitance 27 is denoted as the second node B. Moreover, the junction node of the second electrode of the first transistor 21 and the anode of the light emitting device 25 is denoted as the third node C.

### (1) Initialization Phase

The current pixel is selected, the first scan control signal V_{SCAN[n]} is switched from low to high voltage level, and the second scan control signal V_{EM[n]} maintains at a high voltage level. Thus, all the transistors are turned on, and the level of V_{DD} is changed from V_{DDH} to V_{DDL}. The voltage of the data is the reference voltage V_{REF}, thus the first node A in FIG. 2 is charged up to the reference voltage V_{REF}. As the third transistor 23 is turned on, the second node B and the third node C can be connected through the third transistor 23. Thus the second node B and the third node C are discharged to the low level of _{VDDL}, and V_{DDL}<V_{TH—OLED}. Wherein V_{TH —OLED} is the threshold voltage of the light emitting device 25. Therefore, the light emitting device is turned off and the initialization of the circuit is completed.

### (2) Threshold Extraction Phase

The first and the second scan control signal are maintained high, thus all the transistor are still turned on. And the first voltage source V_{DD[n]} is switched from a low to high voltage level. As the voltage of Data line is still V_{REF}, the first node A maintains the reference voltage of V_{REF}. Thus, the second node B and the third node C are charged up through the first transistor 21 and the third transistor 23. This charging procedure continues until the first transistor 21 is turned off, and the voltage of node B and node C is V_{C}=V_{B}=V_{REF}−V_{TH}_{_}_{T1}, and V_{REF}−V_{TH}_{_}_{T1}<V_{TH}_{_}_{OLED}. Wherein V_{TH1} is the threshold voltage of the first transistor 21, and light emitting device 25 is turned off for this time interval.

### (3) Data Writing Phase

The first scan control signal V_{SCAN[n]} of the current pixel is maintained high, and the second scan control signal V_{EM[n]} is switched from high voltage level to low voltage level. Thus, the third transistor 23 is turned off. In addition, the second node B and the third node C are disconnected. And the level of V_{DD[n]} is maintained high level. And voltage of Data line is changed to gray related level of V_{DATA}. Thus, the node A in FIG. 2 is also charged with V_{DATA}. As the first capacitance 26 and the second capacitance 27 are serially connected, the level of node B can be refreshed as

$${V}_{B} = \frac{C 1}{C 1 + C 2} ( {V}_{DATA} - {V}_{REF} ) + {V}_{REF} - {V}_{TH \_ T 1} \qquad ( 2 )$$

Among them, C1 and C2 are the capacitance value of the first capacitor 26 and the second capacitance of 27, respectively.

To ensure that the OLED does not emit light during programming, the data voltage should be [VDATA]ₘₐₓ−V_{TH}_{_}_{T1}<V_{TH}_{_}_{OLED}, where [VDATA]ₘₐₓ is the maximum value of the data voltage. In this way, OLED is turned off for the entire programming process, thus the contrast of the display can be increased.

After the data is written, the reference driving voltage, which contains the information of gray level and threshold voltage of driving transistor, can be generated by the two electrodes of the first capacitor 25. And the reference driving voltage can be expressed as:

$$\begin{matrix}{V}_{A} - {V}_{B} = {V}_{DATA} - [ \frac{C 1}{C 1 + C 2} ( {V}_{DATA} - {V}_{REF} ) + {V}_{REF} - {V}_{TH \_ T 1} ] \\ = \frac{C 2}{C 1 + C 2} ( {V}_{DATA} - {V}_{REF} ) + {V}_{TH \_ T 1}\end{matrix} \qquad ( 3 )$$

### (4) Light Emitting Phase

The first scan control signal of the current pixel circuit is switched from high to low voltage level, thus the second transistor 22 is turned off. And the second scan control signal V_{EM[n]} is switched from low to high voltage level, thus the third transistor 23 is turned on. As the second node B and the third node C are connected, and the first node A is floating, the third node C is charged up to V_{OLED} with the OLED emitting. Consequently, voltage of the first node A is raised and the voltage difference between the first node A and the second node B can be maintained. Thus the current through OLED is constant, and it can be expressed as

$$\begin{matrix}{I}_{OLED} = \frac{β}{2} {( {V}_{A} - {V}_{B} - {V}_{TH \_ T 1} )}^{2} \\ = \frac{β}{2} {( \frac{C 2}{C 1 + C 2} ( {V}_{DATA} - {V}_{REF} ) + {V}_{TH \_ T 1} - {V}_{TH \_ T 1} )}^{2} \\ = \frac{β}{2} {( \frac{C 2}{C 1 + C 2} ( {V}_{DATA} - {V}_{REF} ) )}^{2}\end{matrix} \qquad ( 4 )$$

From equation (4), it can be observed that the current through OLED is independent of the threshold voltage of the first transistor 21(V_{TH}_{_}_{T1}), and the threshold voltage of OLED (V_{TH}_{_}_{OLED}). And the OLED current is only related with data voltage V_{DATA}, reference voltage V_{REF}, value of the first capacitance C1 and the second capacitance C2 for the current pixel circuit. Thus through optimized design of the reference voltage V_{REF}, the OLED can be maintained turned off for the whole programming phase, thus display with high contrast ratio can be obtained.

Therefore, the pixel circuit provided in this embodiment can compensate threshold voltage shift of the driving transistor and the light emitting device, and the display non-uniformity issue caused by the threshold voltage shift of the driving transistor can be solved. By optimized design of V_{REF}, the OLED device can be turned off for the non-emitting phase for contrast ratio enhancement. In additions, in the case of negative threshold voltage, the conventional diode connection cannot compensate threshold voltage shift as the compensating circuit cannot obtain the exact threshold voltage through discharging method. In the disclosed pixel circuit, due to the source follower structure, both the positive and negative threshold voltage can be compensated. Thus, the disclosed pixel circuit is superior and it is advantageous in the display apparatuses using depletion type transistor for driving transistors.

### Second Embodiment

Another pixel circuit is provided in the disclosed embodiment as shown in FIG. 4. And the major difference between this implementation with that of the first embodiment is that the fourth transistor 24 is added. Thus the second node B and the third node C can be initialized by the fourth transistor 24 corresponding to the third scan control signal. Thus, the first voltage source V_{DD} is not pulse signal, it is constant voltage source instead, and the initialization phase is realized by the fourth transistor 24.

The control electrode of the fourth transistor 24 is connected to the third scan control signal V_{R[n]}, and the first electrode of the fourth transistor 24 is connected to the anode of the light emitting device 25, and the second electrode of the fourth transistor 24 is connected to the third voltage source V_{CM}. Thus, corresponding to the third scan control signal, the second node B and the third node C can be set to a low voltage level for the initialization phase by the fourth transistor 24.

In this embodiment, the driving circuit of the pixel circuit is shown in FIG. 5. And a frame time T can be divided into four phases: initialization phase, threshold extraction phase, data writing phase and the light emitting phase. The operating principle is the same with that of the first embodiment, so there is no need to repeat them here.

In other embodiments, the second electrode of the second capacitor 27 can also be connected to a separate fifth voltage source. The connections of other devices, and driving procedures, are the same with the mentioned pixel circuits, thus details are not repeated here.

In this embodiment, due to the introduction of the third scan control signal and the fourth transistor, all the pixel circuits of the display panel can share the same first voltage source, thus it is much easier for controlling.

### Third Embodiment

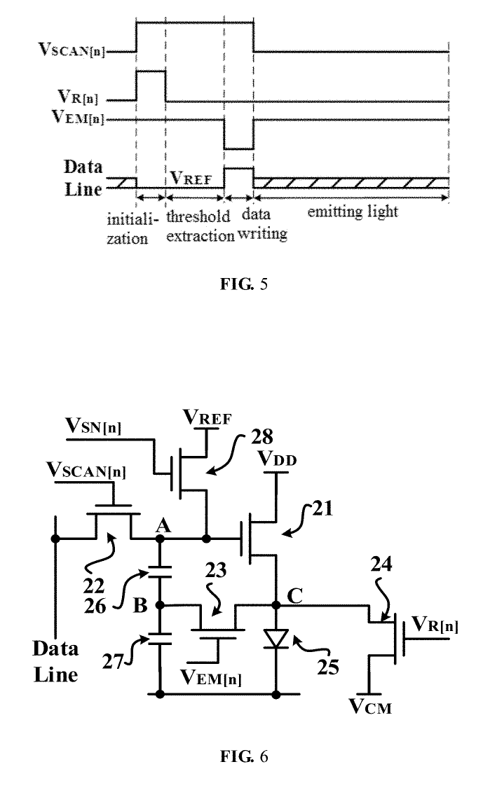

For the present disclosure, another pixel circuit structure is disclosed as shown in FIG. 6. The main difference between this pixel circuit and that of the second embodiment is that the fifth transistor is added, with the control electrode being connected with the fourth scan control signal V_{SN[n]}, and with the first electrode being connected to the fourth voltage source for receiving the constant reference voltage V_{REF}, and with the second electrode being connected with the control electrode of the first transistor 21. And the fifth transistor is used to provide constant reference voltage V_{REF} for the gate electrode of the driving transistor, for the initialization and threshold extraction phases, corresponding to the fourth scan control signal. The advantages of this method are that, the row programming time can be greatly decreased, and the proposed pixel circuit is more suitable for the large area display with high resolution and high frame rate.

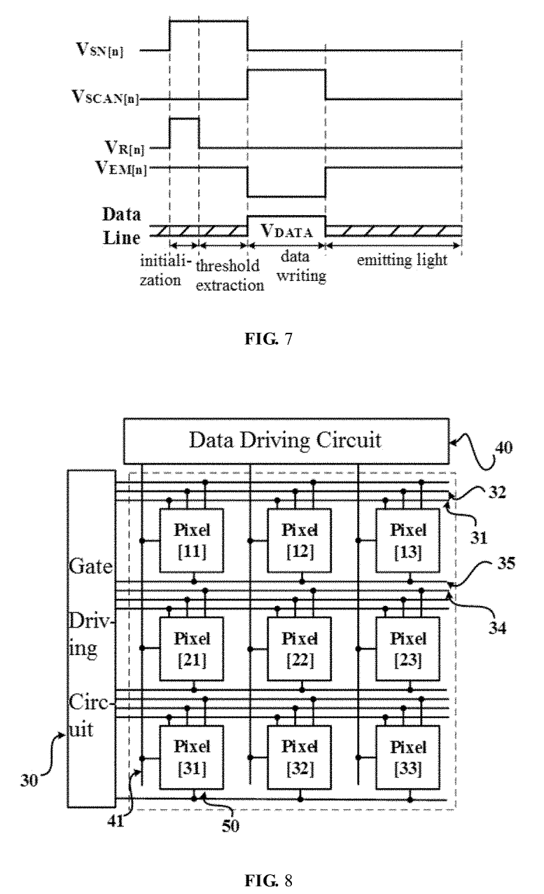

FIG. 7 shows the driving signal waveform for the pixel circuit of the third embodiment. And one frame time T can also be divided into four phases, namely the initialization phase, threshold extraction phase, data writing phase, and light emitting phase. As the working principal is the same with that of the first embodiment, it is no need to repeat here.

In other embodiments, the second electrode of the second capacitor 27 can also be connected to the fifth voltage source separately.

In other embodiments, the initial voltage of the circuit can be provided by the first voltage source, and the fourth transistor 24 is not required. Thus, the first voltage source is with pulse type. And driving procedures can be derived through comparison of the first and the third embodiment, and there is no need to repeat here.

As shown in FIG. 8, the present disclosure also provides the display apparatus, which contains the display panel, the gate driving circuit 30 and the data driving circuit 40. And the display panel includes a plurality of pixels, and the pixel array 50 of M columns and N rows. Wherein M and N are positive integers and pixel circuit of the present disclosure is used.

The gate drive circuit 30 includes the first/second/third/fourth scan control lines both with the number of N for providing respective scan control signals. And the n-th first/second/third/fourth scan control lines are connected with the first/second/third/fourth scan control terminals of pixel circuits of the n-th gate lines, respectively. Wherein n is greater or equal to 1 and it is less or equal to N.

The data driving circuit 40 provides a voltage signal for the M data lines And the m-th data line is connected with the pixel circuit in the m-th column. And m is an integer greater or equal to M.

For the pixel circuit arrays, the pixel circuits of the same row share the first scan control line 31, the second scan control line 32, and the third scan control line 33, and the fourth scan control line 35. And the first scan control line (31), and the second scan control line (32), and the third scan control line (33), and the fourth scan control line (34) can provide the first scan control signal, and the second scan control signal, and the third scan control signal, and the fourth scan control signal for the pixel circuit of the current row, respectively. And all the pixel circuits of the same column are connected with the same data line 41, and when the fourth scan control line are changed from low to high voltage level, it means that the current line is selected, and operating of the pixels of the current line can be carried. And the data line 41 can provide reference voltage V_{REF} and gray level related data V_{DATA} for the data writing phase.

It needs to be addressed that, for the simplicity of description, the pixel circuit array is demonstrated as 3*3 forms in this embodiment. And pixel circuit array can be arranged according to the specific requirements. Moreover, switching transistors in this embodiment can also be P-type, but the circuit connections and driving signals should be adjusted accordingly, and it is not repeated here.

For display device and a pixel circuit of the embodiment, the programming time will not be affected by the initialization and threshold voltage phases. And programming time for every row only includes data input time, i.e. voltage division time for the two capacitances. And threshold extraction is under control of the fourth scan control signal, and only the light emitting time is taken up, and the threshold extraction time far less than the light emitting time. Thus, both high frame frequency and high resolution can be obtained, and threshold voltage accuracy will not be sacrificed.

### Fourth Embodiment

In this embodiment, the fourth scan control line is not needed. And the fourth scan control terminal is connected with the first scan control signal of pixel circuit of the (n-1)-th row.

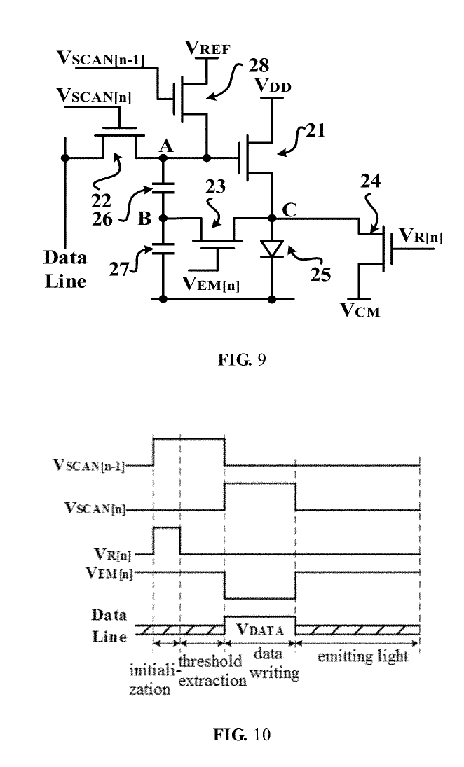

And FIG. 9 and FIG. 10 show the pixel circuit structure and driving waveform diagram, respectively. In this embodiment, the difference of the circuit with that of the third embodiment lies that the control electrode of the fifth transistor is connected with the first scan control signal of the last row. Thus the first scan control signal of last row can be used for initialization and threshold extraction of the current row, and the programming time for each row also includes the initialization and threshold extraction time, and the data input time is less than the sum of initialization and threshold extraction time. And the driving procedure is the same with that of the third embodiment, and the only difference is that the fourth scan control terminal is operated by the first scan control signal of the last row. And the gate driver only needs to generate the first, the second, and the third scan control signal. Compared with the third embodiment, this method has the merits of simplified external circuit, and also the scan control signal number is decreased and increased aperture ratio can be obtained.

In other embodiments, the pixel circuit can be initialized by the first voltage source, which is pulse type signal. And pixel circuit does not need the initialization transistor, i.e. the fourth transistor 24. Thus, the pixel circuit only needs the first and the second scan control signal for this embodiment.

### Fifth Embodiment

The difference of the fifth embodiment and the fourth embodiment is that, the fourth scan control signal of pixel circuit of the n-th row is connected with the first scan control signal of the pixel circuit of the (n-3) row.

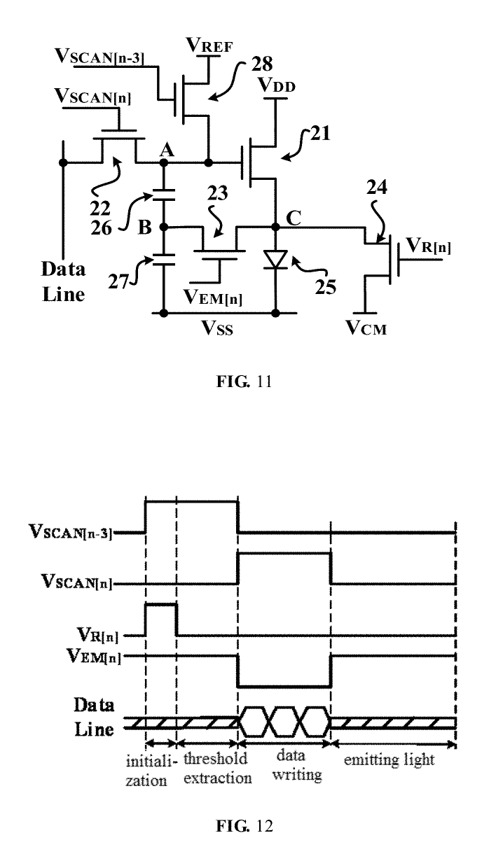

FIG. 11 shows the pixel circuit structure for the disclosed display apparatus. Compared with the pixel circuit in the third embodiment, the control electrode of the fifth transistor 28 is connected with the first scan control signal of the pixel circuit of the (n-3)-th row. Thus the gate electrode of the driving transistor can be provided with constant reference voltage V_{REF} through the fifth transistor 28 under the control of the first scan control signal of the (n-3)-th row, for the initialization and threshold extraction phases. The merits of this method are that the row time can be greatly decreased taking advantage of the overlaps of the first scan control signals. In the case of constant data input time, the equivalent row time can be decreased to ¼ of the row time of the first and the second embodiment, and the threshold extraction time can be extended to be 2 times of the previous embodiment. Thus, the new implementation renders the pixel circuit suitable for large area display with high resolution and high frame rate.

The control electrode of the fifth transistor 28 is connected to the first scan line of the (n-3)-th row, and the first electrode of the fifth transistor 28 is connected to the fourth voltage source, and the second electrode of the fifth transistor 28 is connected to the control electrode of the first transistor 21. Thus the fifth transistor 28 can provide the reliable reference voltage VREF for the control electrode of the driving transistor during the initialization and threshold voltage phases, corresponding to the first scan control signal of the (n-3)-th row.

And the driving signal waveforms of the pixel circuit are shown in FIG. 12. And the frame time T can be divided into 4 phases, initialization phase, threshold extraction phase, data writing phase, and light emitting phase. The operation principal of these phases are the same with that of the first embodiment, thus there is no need to repeat here.

In other embodiments, the second electrode of the second capacitor 27 can also be connected to the fifth voltage source. And the fifth voltage source is connected with the fifth source line of the gate driver circuit.

In other embodiments, the initialization of the pixel circuit is realized by the first signal source, instead of using the fourth transistor 24, and the first voltage source is pulse type signal. The driving method can be derived from the first and the fifth embodiment, and it is not repeated here.

Compared with the third embodiment, the main advantage of the present embodiment is that, the line programming time can be reduced, and at the same time, a scan control signal lien can be eliminated, thus the circuit structure is much simpler. And the display panel structure is the same with that of the fourth embodiment, and it is not repeated here. But the control electrode of the fifth transistor of the n-th row is connected with the first scan control signal of the (n-3)-th row (i.e. V_{SCAN[n-3]}), instead of the first scan control line of the (n-1)-th row(i.e. V_{SCAN[n-1]}).

Of course, in specific embodiments, the fourth scan control signal of the n-th line can be connected with the first scan control signal of pixel circuit of the (n-a)-th row. Wherein a is an integer greater than or equal to 1 and less than n.

### Sixth Embodiment

This embodiment provides another display device, and the difference lies in that, the gate driver circuit does not include the third and the fourth scan control signal. And the fourth scan control terminal and the third scan control terminal of pixel circuit of the n-th row are connected with the first scan control line of the (n-a)-th row, and the first scan control line of the (n-a-b)-th row, respectively. Wherein a is an integer greater than or equal to 1 and b is an integer larger than or equal to 1 and less than (n-a). considering for the initialization for pixels of every rows, the first scan control signal of the (n-a)-th line and the first scan control signal of the (n-a-b)-th line should have a overlapped time with high voltage level, which is the time for realization of the pixel circuit of the n-th row.

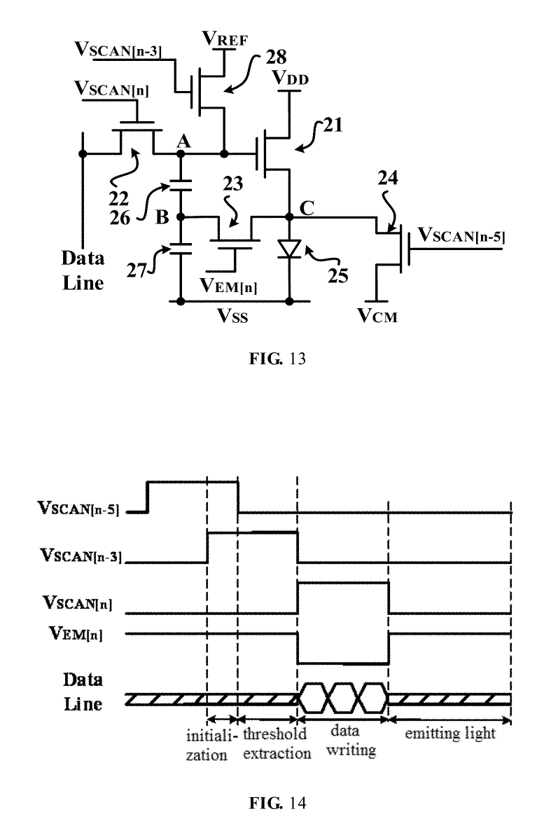

FIG. 13 shows the pixel circuit structure of the display device for the present embodiment. The main difference between the pixel circuit of this embodiment and that of the third embodiment is the both the control terminal of the fourth transistor 24 and the fifth transistor 28 are connected with the first scan control signal of the pervious lines. For example, for the n-th line, then the control electrode of the fourth transistor 24 is connected with the first scan control signal of the (n-5)-th line, and the control electrode of the fifth transistor 28 is connected with first control electrode of the (n-3)-th line. Thus the fourth transistor 24 can provide the initialization voltage V_{LL} for the second node B and the second node C for the initialization phase, correspondent to the first scan control signal, which is provided by the first scan control line V_{SCAN[n-5]}. And the fifth transistor 28 can provide the constant reference voltage V_{REF} for the gate electrode of the driving transistor for the initialization and threshold extraction phase, corresponding to the first scan control signal, which is provided by the first scan control line V_{SCAN[n-3]}. The advantage of this method is that, the third and the fourth scan control line can be saved, and the external circuit can be much simplified. Taking advantage of the scan control signal overlapping, row time can be decreased. Moreover, with the same data input time, the equivalent row time can be decreased to ¼ of that of the first and the second embodiments. And the threshold extraction time is doubled. Thus, the pixel circuit is suitable for the large area display with high resolution and high frame frequency.

The control electrode of the fourth transistor 24 is connected to the first scan control signal of the (n-5)-th row, and the first electrode of the fourth transistor 24 is connected with the anode of the light emitting device, and the second electrode is connected with the second electrode of the first transistor 21. And the fourth transistor is used for initialization of pixel circuit under the control of the first scan control signal of the (n-5)-th line. And the control electrode of the fifth transistor 28 is connected with the first scan control signal of the (n-3)-th line, and the first electrode of the fifth transistor 28 is connected with the fourth voltage source, and the second electrode of the fifth transistor 28 is connected with the control electrode of the first transistor 21. Thus the fifth transistor can be used to providing the reliable reference voltage V_{REF} for the control electrode of the driving transistor for the initialization and threshold voltage phases, corresponding to the first scan control signal of the (n-3)-th line.

In this example, the driving signal waveform of the pixel circuit is shown in FIG. 14, and a frame time T can be divided into four phases: initialization phase, threshold extraction phase, data writing phase and light emitting phase. The principle of all the operating phase is the same with that of the first embodiment, and it is not repeated here.

Compared to the third embodiment, the advantage of this embodiment is that, the first scan control signal of the last row is utilized, thus for the gate driver circuit, only the first and the second scan control lines are required. Considering the row-by-row emitting pixel circuits, the external circuit can be simplified substantially. And taking advantage of the overlap of the first scan control signal, both longer time for threshold extraction and less time for the row programming can be obtained, thus the pixel circuit is more suitable for the large area display with high resolution and high frame frequency.

The above-mentioned embodiments are all implemented with row-by-row emitting way, and the external circuit is relatively complicated. In the following two embodiments, the simultaneous emitting method will be used. For the seventh embodiment, the normal light emitting method is used, thus all the pixel circuits are simultaneously initialized and simultaneously threshold voltage extracted. In order to maintain the turning off of the OLED for the whole programming periods, the first voltage source V_{DD} should be changed to low voltage level. And after the initialization and threshold extraction, the third transistor of the pixel circuit is turned off, and the data voltages are input row by row. And after the data writing phase, the V_{DD} is changed from low to high voltage level. Thus, the third transistor of pixel circuits of the display panel are turned on, and pixel circuits changed to light emitting phase. Due to the adopting of simultaneous initialization and threshold extraction, and simultaneous light emitting, the display panel only require the first voltage source V_{DD} and the second scan control line. The disadvantage of simultaneous emitting method is that, the light emitting time is short and relative large driving current for the light emitting phase is required, thus decay of OLED device due to large driving current is more distinct. For extending of the light emitting phase, grouped programming method is disclosed in the eighth embodiment. For group programming method, firstly all the pixel circuits are divided into c groups, where c is an integer larger than or equal to 1. Then the programming and light emitting of the pixel circuit is realized in the group manner, namely the all the pixels for the same group are initialized and threshold voltage extracted simultaneously. And after data input row by row, the pixels of the same group enters the light emitting phase simultaneously. Then the programming phase of one group is not interference with the light emitting of the other groups, thus the light emitting time can be extended substantially.

### Seventh Embodiment

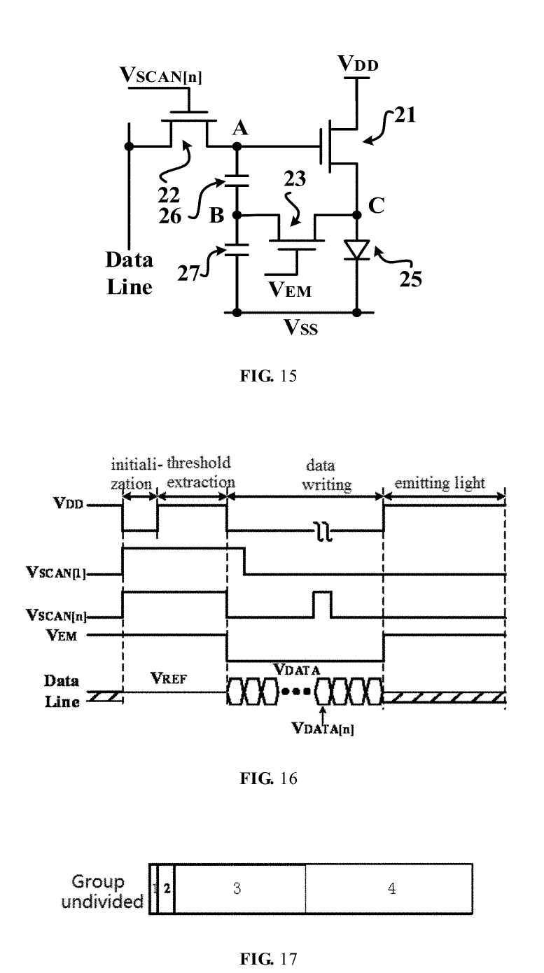

FIG. 15 shows the pixel circuit structure of the display panel for this embodiment. The main difference of the pixel circuit in this embodiment with that of the first embodiment lies in that, the first voltage source V_{DD} and the second scan control signal V_{EM} are not varied by rows, and all the rows share the same first voltage V_{DD} and the second scan control signal V_{EM}.

The first electrode of the first transistor 21 is connected to the first voltage source V_{DD}, and the second electrode of the first transistor 21 is connected to the anode of the light emitting device. And the second electrode of the third transistor 23 is connected to the second scan control line V_{EM} globally, and the first electrode of the third transistor 23 is connected with the anode light emitting device, and the second electrode of the third transistor 23 is connected with the second electrode of the first capacitance. Thus the third transistor 23 is turned on for the initialization, threshold extraction and light emitting phases, by the second scan control signal V_{EM}.

FIG. 16 shows the driving signal waveform of the pixel circuit for this disclosed embodiment. And a frame time T can be divided into four phases: initialization phase, threshold extraction phase, data writing phase and lighting phase.

### (1) Initialization Phase

The first scan line V_{SCAN} for all the display panel is with high level, and the first voltage source V_{DD} is changed from high to low voltage level, and the second scan control signal V_{EM} is with high voltage level. Thus the second transistor 22 and the third transistor 23 of all the display panel is turned on. And the first node A of the di splay panel is charged with reference voltage V_{REF}. And the second node B and the third node C are connected through the third transistor 23, thus the second node B and the third node C can be discharged to a certain low voltage level V_{LL}, which is provide by the second voltage source V_{DD}. And V_{LL}<V_{TH}_{_}_{OLED}. Here V_{TH}_{_}_{OLED} is the threshold voltage of the light emitting device 25. Thus the light emitting device 25 is dark for this phase, and all the pixel circuits for the display panel finish the initialization.

### (2) Threshold Extraction Phase

The first scan lines V_{SCAN} of the display panel is maintaining high voltage level, and the first voltage source V_{DD} is changed from low to high voltage level, and the second scan control signal V_{EM} is high level. Thus, the second transistor 22 and the third transistor 23 are turned on, and the first node A of all the pixel circuits are maintained the reference voltage V_{REF}. And the second node B and the third node C are connected through the switching transistor, thus the second node B and the third node C can be charged by the first voltage source V_{DD} until the first transistor 21 is turned off. By the completion of the discharge of the node B and the node C, the voltage of these two nodes follows the expression as, V_{B}=V_{C}=V_{REF}−V_{TH}_{_}_{T1}, V_{REF}−V_{TH}_{_}_{T1}<V_{TH}_{_}_{OLED}. Here the V_{TH}_{_}_{T1} is the threshold voltage of the first transistor 21. Thus, light emitting device 25 is turned off, and all the pixel circuits of the display panel finish the threshold extraction phase.

### (3) Data Writing Phase:

The second scan control signal V_{EM} is changed high to low voltage level, thus the third transistor of all the pixel circuits in the panel is turned off. And the second node B and the third node C are disconnected. The first voltage source V_{DD} is changing from high to low voltage level, for prevention of the OLED emitting and negative biasing of OLED for decreasing of OLED decay. Then all the pixel circuits start the data input procedures row by row. In the case the first scan control signal V_{SCAN[n]} is changed from low to high voltage level, the first transistor 21 of the current row is turned on. Then the data input procedure for the current line starts, and the data voltage of Data line contains the gray level information V_{DATA}. Due to the serial connection of the first capacitance 26 and the second capacitance 27, voltage of the second node B can be refreshed to

$${V}_{B} = \frac{C 1}{C 1 + C 2} ( {V}_{DATA} - {V}_{REF} ) + {V}_{REF} - {V}_{TH \_ T 1} \qquad ( 5 )$$

After the data is written, the reference driving voltage, which contains the threshold voltage and gray level information, can be generated at the two ends of the first capacitor 25 as:

$$\begin{matrix}{V}_{A} - {V}_{B} = {V}_{DATA} - [ \frac{C 1}{C 1 + C 2} ( {V}_{DATA} - {V}_{REF} ) + {V}_{REF} - {V}_{TH \_ T 1} ] \\ = \frac{C 2}{C 1 + C 2} ( {V}_{DATA} - {V}_{REF} ) + {V}_{TH \_ T 1}\end{matrix} \qquad ( 6 )$$

### (4) Light Emitting Phase:

After the data are written row by row, then the first scan control signal of all the pixel circuits are turned to low level. Thus the second transistors 22 of all the pixel circuits are turned off. The first voltage source V_{DD} is changed from low to high voltage level, and the scan control signal V_{EM[n]} is changed from low to high voltage, thus the third transistor 23 of all the pixel circuits are turned on. And the second node B and the third node C are connected, and the third node C will be charged to V_{OLED} with the turning on and lighting of OLED. Due to the floating of the first node A, the voltage of the node A is raised, and the voltage difference of the first node A and the second node B can be maintained constant. Thus, the OELD current can be expressed as

$$\begin{matrix}{I}_{OLED} = \frac{β}{2} {( {V}_{A} - {V}_{B} - {V}_{TH \_ T 1} )}^{2} \\ = \frac{β}{2} {( \frac{C 2}{C 1 + C 2} ( {V}_{DATA} - {V}_{REF} ) + {V}_{TH \_ T 1} - {V}_{TH \_ T 1} )}^{2} \\ = \frac{β}{2} {( \frac{C 2}{C 1 + C 2} ( {V}_{DATA} - {V}_{REF} ) )}^{2}\end{matrix} \qquad ( 7 )$$

From equation (7) it can observed that the OLED current is independent of the threshold voltage of the first transistor 21, i.e. V_{TH}_{_}_{T1}, and the OLED threshold voltage, i.e. V_{TH}_{_}_{OLED}. And the current is only determined by the data voltage V_{DATA}, and reference voltage V_{REF}, and the value of the first capacitance C1 and the second capacitance C2. Therefore, both threshold voltage of driving transistor V_{TH}_{_}_{T1}, and threshold voltage of OLED V_{TH}_{_}_{OLED} can be compensated. And the luminance non-uniformity issue of the display panel can be solved due to the threshold voltage distributions. Moreover, through proper design of V_{DD} of the first voltage source, OLED can be maintained off for the whole programming procedure to obtain high contrast ratio. In addition, OLED is negatively biased during the data writing phase, thus OLED degradation can be decreased.

### Eighth Embodiment

For this embodiment, all the pixel circuits of the display panel are divided into c groups from top to bottom (and c is an integer greater than or equal to 1 and less than N). And operations of the pixel circuits are operated according to the group settings. For the pixel circuits within the same group, they are programmed simultaneously and light emitted simultaneously. And the programming procedure of the specific group will not interfering with the light emitting procedure of the other groups. And pixel circuits within the same group share the first and the second scan control signals. And when the c is equal to 1, then this embodiment is the same with the seventh embodiment.

When the C value is 1, the display device provided by the embodiment is the same as the embodiment seven.

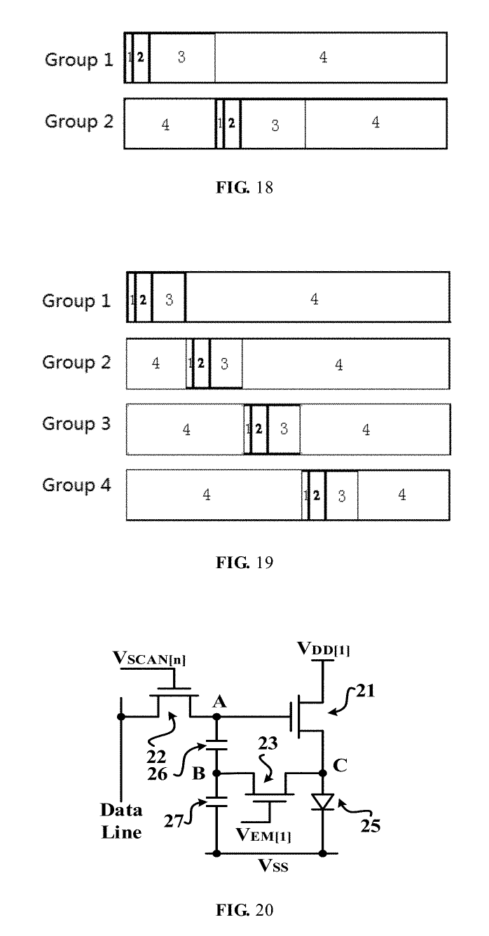

FIG. 17 illustrates the programming and light emitting procedures for the seventh embodiment, which is not being divided into groups. And 1 presents the initialization phase, 2 presents the threshold extraction phase, and 3 presents the data writing phase, and 4 is the light emitting phase. And if the operating time for the initialization, threshold extraction, and data writing phases are kept the same, and the programming and light emitting procedures for the display panel are shown in FIGS. 18 and 19, in the case of pixel circuits grouping. And FIG. 19 shows the case of pixel circuits being grouped by 4.

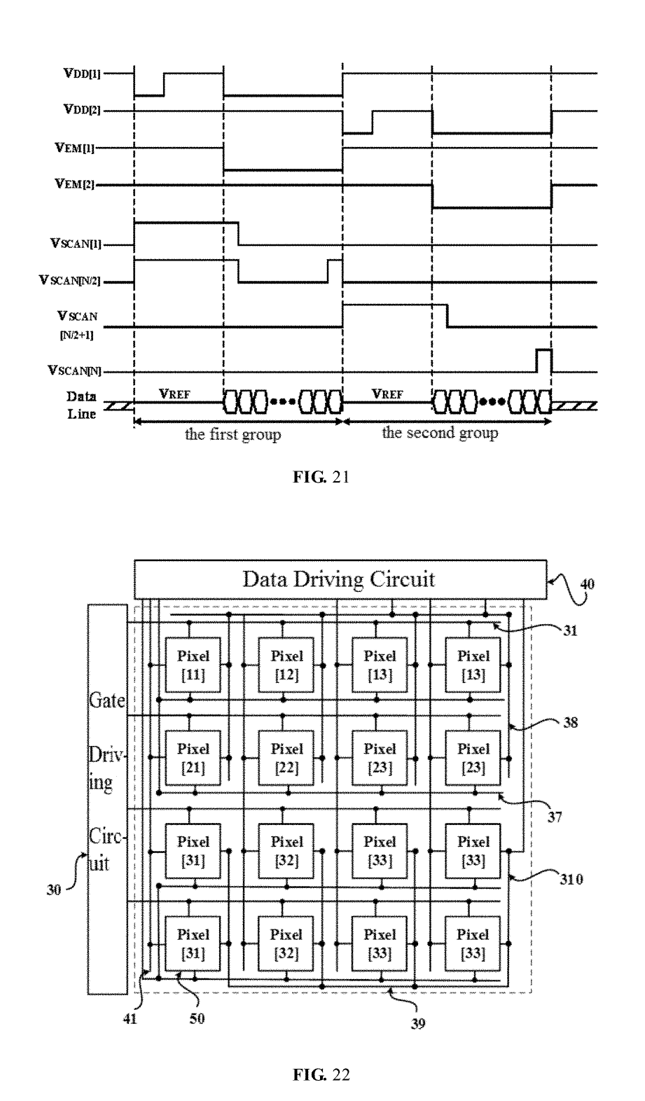

In this embodiment, the pixel circuits are divided into two groups for explaining. For the pixel circuits of the first group, the first voltage source is VDD1, and the second scan control signal is V_{EM1}. And for the pixel circuits of the second group, the first voltage source is V_{DD2}, and the second scan control signal is V_{EM2}. Please refer to FIG. 20 and FIG. 21, compared with the seventh embodiment, the connection relationship is not changed in the circuit, and data line for the entire panel on the pixel circuit is not changed.

The driving signal waveform for the pixel circuit of the embodiment is shown in FIG. 21. Within the same group, the driving procedures of the pixel circuit include the following four phases: initialization phase, threshold extraction phase, data writing phase and light emitting phase. In the same group, all pixel circuits are initialized simultaneously and threshold extracted simultaneously, and data input are arranged row by row. The pixel circuits of the same group enter the light emitting phase after the completion of the data input. And for every operation cycle, only one group is being programmed and it will not interfere the light emit phase of the other groups. The operation principal of the eighth embodiment is similar with that of the seventh embodiment, and the difference lies in that, all the pixels of the display panel are programmed simultaneously for the seventh embodiment, and instead all the pixels of the same group are programmed simultaneously for the eighth embodiment. Thus the details are repeated here.

And in other embodiments, the second electrode of the second capacitance 27 can be connected with the fifth voltage source separately.

FIG. 22 shows the display device consisting of a pixel circuit in this embodiment. And the display device includes the display panel, the gate drive circuit 30 and the data driver circuit 40. The display panel comprises a plurality of pixel arrays, wherein the pixel array is arranged in the form of a matrix of pixel circuit 50 with M rows *N row, wherein the M and the N are positive integers. And the pixel circuit 50 is shown in FIG. 24. Generally speaking, all the pixel circuits 50 of the same row are connected with the first scan control line 31 of the same group. And the first scan control signal 31 can be the first scan control signal of the current line. And all the pixel circuits of the same row are connected with the same data lien 41, which can provide the reference voltage V_{REF} for the initialization and threshold extraction procedures. And when the first scan control signal is switched from low to high voltage level, it means that the current line is selected, and the data input procedure is taken place consequently. The data line 41 can also provide the gray level related data voltage. The first voltage source 37 and the second scan control signal 38 are providing the first voltage source V_{DD1} and the second scan control signal V_{EM1} for the first group, respectively. The first voltage source 39 and the second scan control signal 39 are providing the first voltage source V_{DD2} and the second scan control signal V_{EM2} for the second group, respectively.

It needs to be addressed that, in this embodiment, for the convenience of description, the pixel array is given in the form of 4*4 matrix, and the pixel array can be arranged according to the actual application situation. And the embodiment can also be implemented with P-type transistors, but the circuit connections and driving the signal needs to be modified according to the characteristics of P-type devices.

### Ninth Embodiment

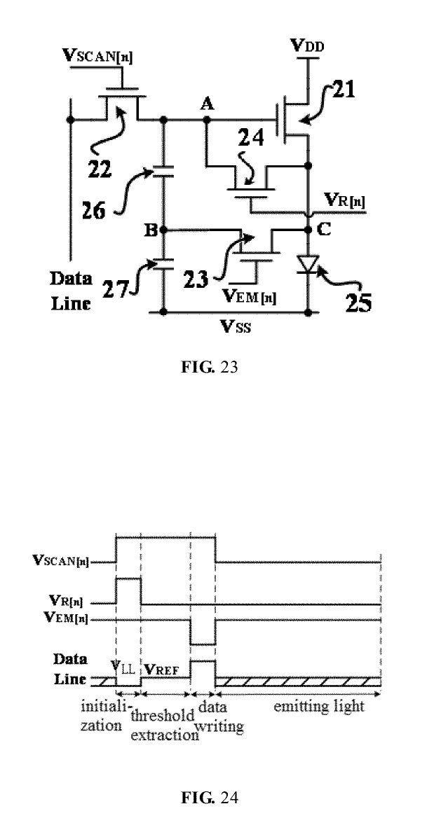

Please refer to FIG. 23, another pixel circuit is provided in this embodiment, and the initial voltage and the reference voltage are provided by the data signal. And the second transistor is used to couple the initial voltage of data line to the first node A for the initialization phase, and to couple the reference voltage of the data line to the first node A for the threshold extraction phase. The pixel circuit is also includes the fourth transistor, with the first electrode being connected to the third node C, and with the second electrode being connected with the first node A, and with the control electrode being connected with the third scan control signal for receiving the third scan control signal. Thus, the fourth transistor can be turned on by the third scan control signal for the initialization phase, for coupling the initial voltage of node A to the third node C.

The main difference between the present embodiment and the second embodiment is that the initial voltage is provided by the data signal, instead of the third voltage source.

In this example, the driving circuit of the pixel circuit is shown in FIG. 24, and a frame time T can also be divided into four phases: initialization phase, threshold extraction phase, data writing stage and the lighting phase. The principle of the operation phases are the same with the first embodiment, and it is not repeated here.

In other embodiments, the second electrode of the second capacitor 27 can also be connected to the fifth voltage source separately.

### Tenth Embodiment

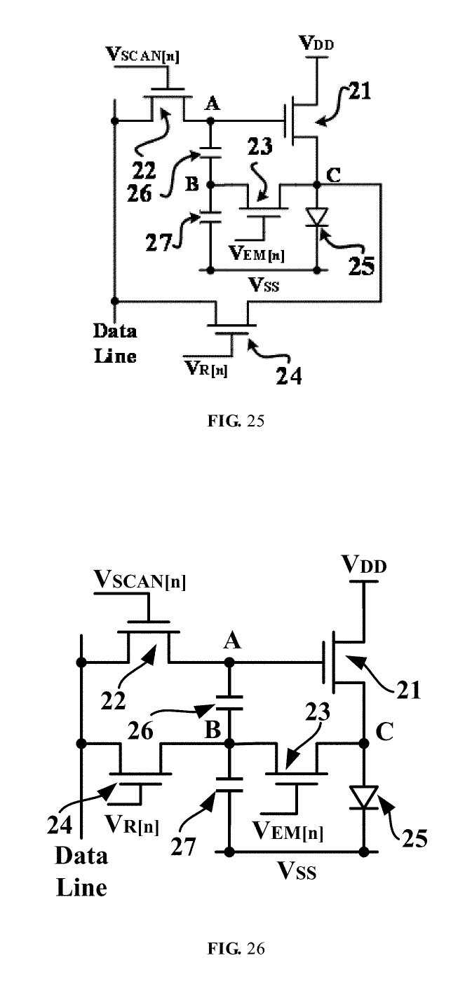

Please refer to FIG. 25, another pixel circuit is provided in this embodiment, and the initialization voltage and the reference voltage are provided by the data line. And the second transistor is used to couple the reference voltage of data line to the first node A for the threshold extraction phase. And pixel circuit further includes the fourth transistor, with the first electrode being connected with the third node C, and with the second electrode being connected with the data line, and with the control electrode being connected with the third scan control signal, which receives the third scan control signal. Thus, the fourth transistor can be turned on by the third scan control signal for the initialization phase, to couple the initial voltage of data line to the third node C.

The main difference between the present embodiment and the second embodiment is that the initial voltage is provided by the data signal, instead of the third voltage source.

In this embodiment, the driving waveform of the pixel circuit is shown in FIG. 24, and a frame time T can be divided into four phases: initialization phase, threshold extraction phase, data writing phase and the lighting phase. The driving process is the same with the ninth embodiment, and it will not be repeated here.

It is worth point that the third transistor 23 is turned on for the initialization phase. Thus for some embodiments, as shown in FIG. 26, the first electrode of the fourth transistor 24 can be connected with the second node B, and the second electrode is connected with the data line, and also the initialization process can be realized. And the driving signal waveforms is the same with that of FIG. 24, and the operating procedures are the same the ninth embodiment, thus it isn't repeated here.

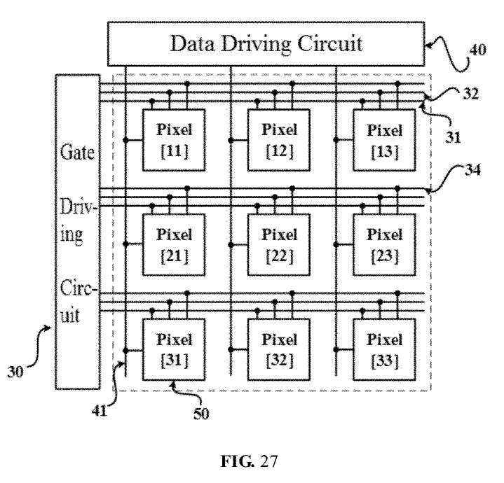

The disclosed embodiment also provides a display device, refer to FIG. 27, and the display device includes the display panel, the gate drive circuit 30 and the data drive circuit 40. And the display panel includes a plurality of pixel array, wherein the pixel array is arranged in a matrix form with M columns *N rows, in which M and N are positive integers, and pixel circuit 50 is realized using pixel circuit provided in the embodiment.

The gate drive circuit 30 includes the first, the second, and the third scan control lines with the number of N. In addition, the n-th the first/second/third scan control lines are connected with the first/second/third scan control terminal of the pixel circuits of the n-th row, respectively. And n is an integer larger than or equal to 1 and less than or equal to N.

The data driving circuit 40 provides a voltage signal for the M data lines, and the m-th data line is connected to the pixel circuit of the m-th column. And m is an integer greater than or equal to 1, and it is less than or equal to M.

For the pixel circuit array, pixel circuits 50 of the same row share the same the first scan control line 31, and the second scan control signal 32, and the third scan control signal 34. And the first scan control signal 31, the second scan control line 32 and the third scan control signal 34, are providing the first scan control signal, and the second scan control signal, and the third scan control signal for the pixel circuits of the current line, respectively. And the pixels circuits of the same column share the same data line 41. When the first scan control signal is switched from low to high voltage level, it means that the current line is selected, and the current line pixels can be operated consequently. The data line provides the initial voltage V_{LL}, the reference voltage V_{REF}, and the gray level related data voltage V_{DATA} for the data input stage.

The first voltage source and the second voltage source are provided by the external circuit.

It needs to be addressed that, in this embodiment, in order to simplify the descriptions, the pixel array is provided in form of 3*3 matrix. And the pixel array can be arranged according to the actual situations. The transistors in this embodiment can also be the P-type transistors, but the circuit connections and signal driving should be modified according to the characteristics of P-type transistors. And the details are not repeated here.

Considering the above detailed explanation of disclosed embodiments with the specific implementation method, one cannot suppose the possible implementation method is limited to disclose ones of the descriptions. For the general technical personnel in this field, according to the thought of the disclosure, the specific implementation of the above methods can be changed.

What is claimed is:

1. A pixel circuit, wherein a frame time of the pixel circuit comprises an initialization phase, a threshold extraction phase, a data writing phase, and a light emitting phase, and the pixel circuit comprising:
a first transistor and a light emitting device, which are serially connected between a high voltage level and a low voltage level, and the first transistor is configured to provide a driving current for the light emitting device for the light emitting phase, and the light emitting device is configured to emit light according to the driving current, and the high voltage level is provided by a first voltage source, and the low voltage level is provided by a second voltage source;
a second transistor, which is connected between a data line and a control electrode of the first transistor, and a control electrode of the second transistor is connected with a first scan control terminal for receiving a first scan control signal to select the pixel circuit, and the second transistor is turned on for the data writing phase by the first scan control signal for applying data voltage of data line to a control electrode of the first transistor, and thus the first transistor can be controlled to provide the driving current for the light emitting device;
a storage unit, being connected between the control electrode of the first transistor and the second voltage source, or being connected between the control electrode of the first transistor and a fifth voltage source, and the second voltage source and the fifth voltage source is used to provide the low voltage level for storing the data voltage of the data line;
wherein the storage unit comprises a first capacitance, a second capacitance and a third transistor, and the first capacitance and the second capacitance are connected between the control electrode of the first transistor and the low voltage level, and providing a reference voltage for the control electrode of the first transistor for the initialization phase and the threshold extraction phase, and
a first electrode of the third transistor is connected with the junction node of the first capacitance and the second capacitance, a second electrode of the third transistor is connected with the junction node of the first transistor and the light emitting device, and an initial voltage is coupled with the second electrode of the third transistor for the initialization phase, and the control electrode of the third transistor is connected with a second scan control terminal for receiving a second scan control signal, and the third transistor is turned off by the second scan control signal for the data writing phase.

2. The pixel circuit of claim 1, wherein the second transistor is turned on by the first scan control signal for the initialization phase and the threshold extraction phase, and the reference voltage is provided by the data line, and the reference voltage is coupled to the control electrode of the first transistor by the second transistor under the control of the first scan control signal,
and the initial voltage is provided by the first voltage source, and the initial voltage is coupled to the second electrode of the third transistor through the first transistor.

3. The pixel circuit of claim 1, wherein the reference voltage is provided by the data line, and the reference voltage is coupled to the control electrode of the first transistor for the initialization and threshold extraction phases by the second transistor,
the pixel circuit further comprises a fourth transistor, wherein a first electrode of the fourth transistor is connected with the junction node of the first transistor and the light emitting device, and a second electrode of the fourth transistor is connected with a third voltage source, and a control electrode of the fourth transistor is connected with a third scan control terminal,
and the third scan control terminal is used for receiving a third scan control signal, and the fourth transistor is turned on by the third scan control signal, thus an initial voltage of the third voltage source is coupled to the junction node of the first transistor and the light emitting device.

4. The pixel circuit of claim 1, wherein the initial voltage of the first voltage source is coupled to the junction node of first transistor and the light emitting device through the first transistor for the initialization phase, and the pixel circuit further comprises a fifth transistor, wherein a first electrode of the fifth transistor is connected with a fourth voltage source, and a second electrode of the fifth transistor is connected with the control electrode of the first transistor, and a control electrode of the fifth transistor is connected with a fourth scan control terminal,
and the fourth scan control terminal is used to receive a fourth scan control signal,
and the fifth transistor is used to couple the reference voltage of the fourth voltage source to the control electrode of the first transistor for the initialization phase and the threshold extraction phase.

5. The pixel circuit of claim 1, further comprising:
a fourth transistor, wherein a first electrode of the fourth transistor is connected to junction node of the first transistor and the light emitting device, and a second electrode of the fourth transistor is connected to a third voltage source, and a control electrode of the fourth transistor is connected to a third scan control terminal,
and the third scan control terminal is used to receive a third scan control signal,
and the fourth transistor is used to couple an initial voltage of the third voltage source to the junction node of the first transistor and the light emitting device; and
a fifth transistor, wherein a first electrode of the fifth transistor is connected to a fourth voltage source, and a second electrode of the fifth transistor is connected to the control electrode of the first transistor, and a control electrode of the fifth transistor is connected to a fourth scan control terminal,
and the fourth scan control terminal is used to receive a fourth scan control signal,
and the fifth transistor is used to couple a reference voltage of the fourth voltage source to the control electrode of the first transistor for the initialization phase and the threshold extraction phase.

6. The pixel circuit of claim 1, wherein the initial voltage and the reference voltage are provided by the data line, and the second transistor is used to couple the initial voltage of the data line to the control electrode of the first transistor for the initialization phase, and couple the reference voltage of the data line to the control electrode of the first transistor for the threshold extraction phase; and the pixel circuit further comprising:
a fourth transistor, wherein a first electrode of the fourth transistor is connected with the junction node of the first transistor and the light emitting device, and a second electrode of the fourth transistor is connected with the control electrode of the first transistor, and a control electrode of the fourth transistor is connected with a third scan control terminal; the third scan control terminal is used to receive a third scan control signal, and the fourth transistor is turned on by the third scan control signal, thus the initial voltage of the control electrode of the first transistor can be coupled to the junction node of the first transistor and the light emitting device as well as the junction node of the first capacitance and the second capacitance.

7. A display device, comprising:
a display panel, comprising a matrix of pixel circuits with M columns and N rows, and the pixel circuit is implemented with the pixel circuit structure of claim 1, and M and N are a positive integer;
a gate drive circuit, configured to provide the first scan control signal with the number of N, and to provide the second scan control signal with the number of N;
a data driving circuit, configured to provide data signals for the M data lines, and to provide the first voltage source for an X first voltage source lines; wherein an m-th data line is connected with the pixel circuits of the m-th columns, and m is an integer larger than or equal to 1, and less than or equal to M; and the data line is configured to provide the reference voltage for the initialization phase and the threshold extraction phase, and also provide gray level related data voltage for data writing phase, for the pixel circuits of corresponding columns, wherein X is an integer greater than or equal to 1, and less than or equal to N, and the value of X depends on the number of pixel circuits that are initialized and threshold voltage extracted simultaneously; in the case there are pixels of x rows being initialized simultaneously, then X=N/x; and in the case X=N, the pixel circuit of the display panel is emitting row by row; and in the case X=1, then pixel circuits of the display panel is emitting simultaneously; and in the case X is greater than 1 and less than N, pixel circuits for the display panel is divided into X groups, and pixel circuits within the same group finishes the initialization phase simultaneously, and also finishes the threshold extraction phase simultaneously, and also finish the light emitting phase simultaneously; and the first voltage source provides the first voltage source for the pixel circuits;
wherein the second transistor is turned on by the first scan control signal, for the initiation phase, and the threshold voltage phase, and the data writing phase according to the first scan control signal, the reference voltage is coupled to the control electrode of the first transistor through the second transistor; and the initial voltage provided by the first voltage source is coupled to the second electrode of the third transistor, and also to the junction node of the first capacitance and the second capacitance through the first transistor;
a constant voltage source of the second voltage source and the fifth voltage source is provided by external circuits.

8. The display device of claim 7, wherein the pixel circuit further comprising:
a fourth transistor, wherein a first electrode of the fourth transistor is connected to the junction node of the first transistor and the light emitting device, and a second electrode of the fourth transistor is connected with a third voltage source, and a control electrode of the fourth transistor is connected with a third scan control terminal; and the third scan control terminal is configured to receive a third scan control signal; and the fourth transistor is configured to couple an initial voltage of the third voltage source to the junction node of the first transistor and the light emitting device;
a fifth transistor, wherein a first electrode of the fifth transistor is connected with a fourth voltage source, and a second electrode of the fifth transistor is connected with the control electrode of the first transistor, and a control electrode of the fifth transistor is connected with a fourth scan control terminal; and the fourth scan control terminal is configured to receive a fourth scan control signal; the fifth transistor is configured to couple a reference voltage of the fourth voltage source to the control electrode of the first transistor during the initialization phase and the threshold extraction phase;
a gate drive circuit, configured for providing respective scan control signals for first scan control lines with the number of N, and second scan control lines with the number of N, and third scan control lines with the number of N, and fourth scan control lines with the number of N; the n-th first scan control signal is connected with the first scan control terminal of the pixel circuit of the n-th row, and the n-th second scan control signal is connected with the second scan control terminal of the pixel circuit of the n-th row, and the n-th third scan control signal is connected with the third scan control terminal of the pixel circuit of the n-th row, and the n-th fourth scan control signal is connected with the fourth scan control terminal of the pixel circuit of the n-th row, wherein n is an integer larger than or equal to 1, and less than or equal to N,
wherein the first scan control line is configured to provide the first scan control signal for the pixels of corresponding row, and the second scan control line is configured to provide the second scan control signal for the pixels of corresponding row, and the third scan control line is configured to provide the third scan control signal for the pixels of corresponding row, and the fourth scan control line is configured to provide the fourth scan control signal for the pixels of corresponding row, and the third voltage source is configured to provide initial voltage for pixels of every row, and the fourth voltage source is configured to provide reference voltage for pixels of every row; and
a data driving circuit, configured for providing voltage signal for M data lines, wherein m-th data line is connected with the pixel circuit of the m-th row, wherein m is greater than or equal to 1, and less than or equal to M; and the data line is used to provide reference voltage and gray level related data voltage for the initialization phase, the threshold extraction phase, and the data writing phase respectively;
wherein the constant voltage source of the first voltage source, the second voltage source, the third voltage source, the fourth voltage source, and the fifth voltage source are all provided by the external circuits.

9. The display device of claim 8, wherein the gate driver doesn't include the third scan control line and the fourth scan control line, and the fourth scan control terminal of the pixel circuits of the n-th row is connected with the first scan control line of the pixel circuit of the (n-a)-th row, and the third scan control terminal of the pixel circuits of the n-th row is connected with the first scan control terminal of the pixel circuits of the (n-a-b)-th row, wherein a is an integer larger than or equal to 1, and less than n; and b is an integer larger than or equal to 1, and less than (n-a).

10. The display device of claim 7, wherein the pixel circuit further comprising:
a fourth transistor, wherein a first electrode of the fourth transistor is connected to the junction node of the first transistor and the light emitting device, and a second electrode of the fourth transistor is connected to the data line, and a control electrode of the fourth transistor is connected to a third scan control terminal; and the third scan control terminal is configured to receive a third scan control signal; the initial voltage is provided by the data driving circuit rather than the first voltage source; and the fourth transistor is configured to couple the initial voltage of the data line to the junction node of the first transistor and the light emitting device as well as the junction node of the first capacitance and the second capacitance;
a gate driving circuit, configured for providing respective scan control signals for first scan control lines with the number of N, and second scan control lines with the number of N, and third scan control lines with the number of N; the n-th first scan control signal is connected with the first scan control terminal of the pixel circuit of the n-th row, and the n-th second scan control signal is connected with the second scan control terminal of the pixel circuit of the n-th row, and the n-th third scan control signal is connected with the third scan control terminal of the pixel circuit of the n-th row, wherein n is an integer larger than or equal to 1, and less than or equal to N,
wherein the first scan control line is configured to provide the first scan control signal for the pixels of corresponding rows, and the second scan control line is used to provide the second scan control signal for the pixels of corresponding rows, and the third scan control line is used to provide the third scan control signal for the pixels of corresponding rows;
a data driving circuit, configured for providing voltage signal for M data lines, wherein m-th data line is connected with the pixel circuit of the m-th row, wherein m is greater than or equal to 1, and less than or equal to M; and the data line is configured to provide reference voltage and gray level related data voltage for the initialization phase, the threshold extraction phase, and the data writing phase;
the constant voltage source of the first voltage source, the second voltage source, the third voltage source, the fourth voltage source, and the fifth voltage source are all provided by the external circuits.

11. The pixel circuit of claim 1, wherein the initial voltage and the reference voltage are provided by the data line, and the second transistor is used to couple the initial voltage of the data line to the control electrode of the first transistor for the initialization phase, and couple the reference voltage of the data line to the control electrode of the first transistor for the threshold extraction phase; and the pixel circuit further comprising:
a fourth transistor, wherein a first electrode of the fourth transistor is connected with the junction node of the first transistor and the light emitting device, and a second electrode of the fourth transistor is connected with data line, and a control electrode of the fourth transistor is connected with a third scan control terminal which is used to receive a third scan control signal; and the fourth transistor is turned on by the third scan control signal, thus the initial voltage of the data line is coupled to the junction node of the first transistor and the light emitting device.

12. The pixel circuit of claim 1, wherein the initial voltage and the reference voltage are provided by the data line, and the second transistor is used to couple the initial voltage of the data line to the control electrode of the first transistor for the initialization phase, and couple the reference voltage of the data line to the control electrode of the first transistor for the threshold extraction phase; and the pixel circuit further comprises:
a fourth transistor, wherein a first electrode of the fourth transistor is connected to the junction node of the first capacitance and the second capacitance, and a second electrode of the fourth transistor is connected with the data line, and a control electrode of the fourth transistor is connected with a third scan control terminal which is used to receive a third scan control signal; the fourth transistor is turned on by the third scan control signal, thus the initial voltage of the data line can be coupled to the junction node of the first capacitance and the second capacitance.

13. The display device of claim 7, wherein the pixel circuit further comprising:
a fourth transistor, wherein a first electrode of the fourth transistor is connected to the junction node of the first capacitance and the second capacitance, and a second electrode of the fourth transistor is connected with the data line, and a control electrode of the fourth transistor is connected with a third scan control terminal which is used to receive a third scan control signal; the initial voltage is provided by the data driving circuit rather than the first voltage source, wherein the fourth transistor is configured to couple the initial voltage of the data line to the junction node of the first transistor and the light emitting device as well as the junction node of the first capacitance and the second capacitance;
a gate driving circuit, configured for providing respective scan control signals for first scan control lines with the number of N, and second scan control lines with the number of N, and third scan control lines with the number of N; the n-th first scan control signal is connected with the first scan control terminal of the pixel circuit of the n-th row, and the n-th second scan control signal is connected with the second scan control terminal of the pixel circuit of the n-th row, and the n-th third scan control signal is connected with the third scan control terminal of the pixel circuit of the n-th row, wherein n is an integer larger than or equal to 1, and less than or equal to N,
wherein the first scan control line is configured to provide the first scan control signal for the pixels of corresponding rows, and the second scan control line is used to provide the second scan control signal for the pixels of corresponding rows, and the third scan control line is used to provide the third scan control signal for the pixels of corresponding rows;
a data driving circuit, configured for providing voltage signal for M data lines, wherein m-th data line is connected with the pixel circuit of the m-th row, wherein m is greater than or equal to 1, and less than or equal to M; and the data line is configured to provide reference voltage and gray level related data voltage for the initialization phase, the threshold extraction phase, and the data writing phase;
the constant voltage source of the first voltage source, the second voltage source, the third voltage source, the fourth voltage source, and the fifth voltage source are all provided by the external circuits.

14. The display device of claim 7, wherein the pixel circuit further comprising:
a fourth transistor, wherein a first electrode of the fourth transistor is connected to junction node of the first transistor and the light emitting device, and a second electrode of the fourth transistor is connected to the control electrode of the first transistor, and a control electrode of the fourth transistor is connected to a third scan control terminal which is configured to receive a third scan control signal; the initial voltage is provided by the data driving circuit rather than the first voltage source, wherein the fourth transistor is configured to couple the initial voltage of the data line to the junction node of the first transistor and the light emitting device as well as the junction node of the first capacitance and the second capacitance;
a gate driving circuit, configured for providing respective scan control signals for first scan control lines with the number of N, and second scan control lines with the number of N, and third scan control lines with the number of N; the n-th first scan control signal is connected with the first scan control terminal of the pixel circuit of the n-th row, and the n-th second scan control signal is connected with the second scan control terminal of the pixel circuit of the n-th row, and the n-th third scan control signal is connected with the third scan control terminal of the pixel circuit of the n-th row, wherein n is an integer larger than or equal to 1, and less than or equal to N,
wherein the first scan control line is configured to provide the first scan control signal for the pixels of corresponding rows, and the second scan control line is used to provide the second scan control signal for the pixels of corresponding rows, and the third scan control line is used to provide the third scan control signal for the pixels of corresponding rows;
a data driving circuit, configured for providing voltage signal for M data lines, wherein m-th data line is connected with the pixel circuit of the m-th row, wherein m is greater than or equal to 1, and less than or equal to M; and the data line is configured to provide reference voltage and gray level related data voltage for the initialization phase, the threshold extraction phase, and the data writing phase;
the constant voltage source of the first voltage source, the second voltage source, the third voltage source, the fourth voltage source, and the fifth voltage source are all provided by the external circuits.
